(19) United States
(12) Patent Application Publication
(10) Pub. No.: US 2016/0171594 A1
(43) Pub. Date: Jun. 16, 2016

(54) Method and a Device for Searching Premium Merchant Based on an Intelligent Terminal

(71) Applicant: Xinyu Xingbang Information Industry Co., Ltd, Xinyu (CN)

(72) Inventors: Xiaohong Yao, Foshan (CN); Jiajian Zhou, Foshan (CN)

(73) Assignee: Xinyu Xingbang Information Industry Co., Ltd

(21) Appl. No.: 14/709,501

(22) Filed: May 12, 2015

(30) Foreign Application Priority Data
Dec. 16, 2014 (CN) 201410782532.5

(51) Int. Cl. G06Q 30/06; H04W 4/02

(52) U.S. Cl. CPC G06Q 30/0639; H04W 4/023; H04W 4/027; G06Q 30/0631

(57) ABSTRACT

The invention discloses a method and a device thereof for searching the premium merchant based on an intelligent terminal, wherein, the intelligent terminal is provided with an acceleration sensor and a control module connected to the acceleration sensor; the control module is provided with a timer; the method comprises: judging whether the acceleration sensor outputs a signal; assigning 1 to the timer, searching the most premium merchant within a first preset distance range by a remote server and sending the searching results to the intelligent terminal; judging whether the acceleration sensor outputs a signal once again; judging whether the number of times that the acceleration sensor outputs the signal is less than or equal to a preset number of times. The invention has the following beneficial effects of an enhanced somatosensory interaction and an improved user experiencing.

### CROSS REFERENCE TO RELATED APPLICATIONS

This application claims priority of Chinese patent application No. 201410782532.5 filed on Dec. 16, 2014, the contents of which all hereby incorporated by reference.

### FIELD OF THE INVENTION

The invention relates to the field recommended by merchants, and in particular relates to a method and a device thereof for searching the premium merchant based on an intelligent terminal.

### BACKGROUND OF THE INVENTION

The search function in the existing intelligent terminal application is relatively traditional and boring, which generally converts voice into characters by conventional text input or voice engine and then searches the characters, without somatosensory interaction with the intelligent terminal user; after a certain period, the user will probably end up searching by the software due to the monotonous searching habit, which will cause negative influence on the user experiencing.

### SUMMARY OF THE INVENTION

In order to solve the technical problems of the prior art which is lack in somatosensory interaction and causes negative influence on the user experiencing, the invention provides a method and a device thereof for searching the premium merchant based on an intelligent terminal for enhancing somatosensory interaction and improving user experiencing.

The technical scheme of the invention to solve the technical problems mentioned above is to construct a method for searching the premium merchant based on an intelligent terminal provided with an acceleration sensor and a control module connected to the acceleration sensor; the control module is provided with a timer; the method comprises:

A) Judging whether the acceleration sensor outputs a signal, if so, executing step B); otherwise, continuing to conduct the judgment of this step;

B) Assigning 1 to the timer, searching the most premium merchant within a first preset distance range by a remote server and sending the searching results to the intelligent terminal, and executing step C), the timer is used for calculating the number of times that the acceleration sensor outputs the signal;

C) Judging whether the acceleration sensor outputs a signal once again, if so, executing step D); otherwise, continuing to conduct the judgment of this step;

D) Judging whether the number of times that the acceleration sensor outputs the signal is less than or equal to a preset number of times, if so, adding 1 to the timer, searching the most premium merchant within the N^{th} preset distance range by the remote server and sending the searching results to the intelligent terminal, wherein N is equal to the value of the timer; otherwise, returning to step B).

According to the method for searching the premium merchant based on the intelligent terminal, the step B) further comprises:

B1) Assigning 1 to the timer;

B2) Transmitting the location information and the first preset distance range to the remote server by the intelligent terminal;

B3) Searching all merchants of the distance with the intelligent terminal within the first preset distance range by the remote server;

B4) Comparing all of the searched merchants to obtain the most premium merchant by the score, and sending the searching results to the intelligent terminal.

According to the method for searching the premium merchant based on the intelligent terminal, the step B4) further comprises:

B41) Initializing premium scoring coefficient as 0;

B42) Receiving evaluation on current merchant, and adding 1 to the premium scoring coefficient;

B43) Judging whether the premium score is more than or equal to a preset score, if so, adding 2 to the premium scoring coefficient and executing step B45); otherwise, executing step B44);

B44) Judging whether the premium score is less than the preset score but more than or equal to 1, if so, subtracting 1 from the premium scoring coefficient and executing step B45); otherwise, subtracting 2 from the premium scoring coefficient and executing step B45);

B45) Updating the premium scoring performance of the current merchant;

B46) Judging whether the premium scoring performance is more than or equal to a preset lower limit value, if so, storing the premium scoring performance and executing step B47); otherwise, making the premium scoring performance equal to the preset lower limit value, storing the premium scoring performance and executing step B47);

B47) Judging whether all merchants are traversed, if so, sorting out the merchant with the most premium scoring performance as the most premium merchant and displaying the information of the most premium merchant on the intelligent terminal; otherwise, finding out the next merchant and returning to step B41).

According to the method for searching the premium merchant based on the intelligent terminal, the step D) of searching a premium merchant within the N^{th} preset distance range by the remote server and sending the searching results to the intelligent terminal is carried out in accordance with process of the step B4).

According to the method for searching the premium merchant based on the intelligent terminal, the first preset distance range is 500 m, the preset number of times is 4, the preset score is 3 and the preset lower limit value is −50.

Furthermore, the invention relates to a device for implementing the method for searching the premium merchant based on the intelligent terminal; the intelligent terminal is provided with an acceleration sensor and a control module connected to the acceleration sensor; the control module is provided with a timer; the device comprises:

A signal output judging unit: for judging whether the acceleration sensor outputs a signal;

A first searching unit: for assigning 1 to the timer, searching the most premium merchant within a first preset distance range by a remote server and sending the searching results to the intelligent terminal, wherein the timer is used for calculating the number of times that the acceleration sensor outputs the signal;

A re-output judging unit: for judging whether the acceleration sensor outputs a signal once again;

A preset number of times judging unit: for judging whether the number of times that the acceleration sensor outputs the signal is less than or equal to a preset number of times, if so, adding 1 to the timer, searching the most premium merchant within the N^{th} preset distance range by the remote server and sending the searching results to the intelligent terminal, wherein N is equal to the value of the timer; otherwise, returning.

According to the device for implementing the method for searching the premium merchant based on the intelligent terminal, the first searching unit further comprises:

An initializing module: for assigning 1 to the timer;

A transmitting module: for transmitting location information and the first preset distance range to the remote server by the intelligent terminal;

A first preset searching module: for searching all merchants of the distance with the intelligent terminal within the first preset distance range by the remote server;

A score comparing module: for comparing all of the searched merchants to obtain the most premium merchant by the score, and sending the searching results to the intelligent terminal

According to the device for implementing the method for searching the premium merchant based on the intelligent terminal, the score comparing module further comprises:

A coefficient initializing module: for initializing the premium scoring coefficient as 0;

An evaluation receiving module: for receiving evaluation on the current merchant, and adding 1 to the premium scoring coefficient;

A first premium score judging module: for judging whether the premium score is more than or equal to a preset score, if so, adding 2 to the premium scoring coefficient; otherwise, continuing to judge the premium score;

A second premium score judging module: for judging whether the premium score is less than the preset score but more than or equal to 1, if so, subtracting 1 from the premium scoring coefficient; otherwise, subtracting 2 from the premium scoring coefficient;

An updating module: for updating the premium scoring performance of the current merchant;

A score judging module: for judging whether the premium scoring performance is more than or equal to a preset lower limit value, if so, storing the premium scoring performance; otherwise, making the premium scoring performance equal to the preset lower limit value, storing the premium scoring performance;

A traversal unit: for judging whether all merchants are traversed, if so, finding out the merchant with the highest premium scoring performance as the most premium merchant and displaying the information of the most premium merchant on the intelligent terminal; otherwise, finding out the next merchant and returning.

According to the device for implementing the method for searching the premium merchant based on the intelligent terminal, the preset number of times judging unit carries out searching a premium merchant within the N^{th} preset distance range by the remote server and sending the searching results to the intelligent terminal in accordance with process implemented by the score comparing module.

According to the device for implementing the method for searching the premium merchant based on the intelligent terminal, the first preset distance range is 500 m, the preset number of times is 4, the preset score is 3 and the preset lower limit value is −50.

The method and the device thereof for searching the premium merchant based on the intelligent terminal have the following beneficial effects: as the intelligent terminal is provided with the acceleration sensor, the acceleration sensor will output the signal when the intelligent terminal is shaken; by judging whether the acceleration sensor outputs the signal, it can determine that whether the user is from the shaken intelligent terminal, if so, the remote server will search the most premium merchant within the preset distance range and display the information of the most premium merchant on the intelligent terminal; so that somatosensory interaction of the user is enhanced and the user experiencing is improved.

### BRIEF DESCRIPTION OF THE DRAWINGS

In order to clearly illustrate the technical schemes of the embodiments of the invention, the drawings of the embodiments will be briefly described in the following; it is obvious that the described drawings are only related to some embodiments of the invention; for those skilled in the art, on the precondition of not making creative efforts, other attached drawings can be obtained based on the attached drawings below.

FIG. 1 is a flow chart of the method in one embodiment of the method and the device thereof for searching the premium merchant based on the intelligent terminal of the invention.

FIG. 2 is a specific flow chart of assigning 1 to timer, searching the most premium merchant within the first preset distance range and sending the searching results to the intelligent terminal according to the embodiment.

FIG. 3 is a specific flow chart of comparing all of the searched merchants to obtain the most premium merchant by the score and sending the searching results to the intelligent terminal according to the embodiment.

FIG. 4 is a schematic diagram of interacting process between the intelligent terminal and the remote server according to the embodiment.

FIG. 5 is a structural schematic diagram of the device according to the embodiment.

### DESCRIPTION OF THE PREFERRED EMBODIMENTS

The technical schemes of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art, without any inventive efforts, can obtain other embodiment(s), which should be within the protection scope of the invention.

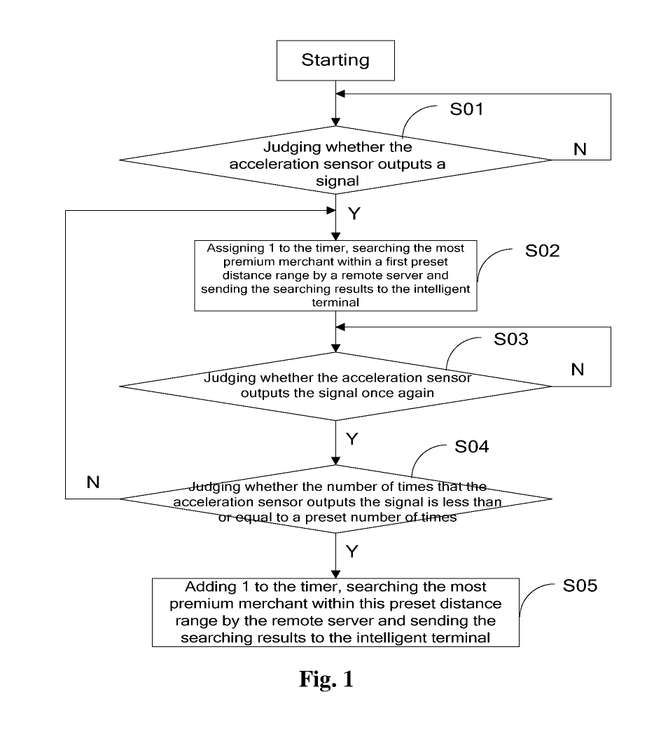

According to the embodiment of the method and the device thereof for searching the premium merchant based on the intelligent terminal of the invention, the flow chart of the method for searching the premium merchant based on the intelligent terminal is shown in FIG. 1. The invention is based on an intelligent system recommending the enterprises nearby by a way of shaking; the intelligent system comprises a remote server and an intelligent terminal; both the remote server and the intelligent terminal are provided with communication modules thereon; the intelligent terminal is additionally provided with an acceleration sensor and a control module; the acceleration sensor is connected to the control module; the control module is provided with a timer. As shown in FIG. 1, the method for searching the premium merchant based on the intelligent terminal comprises the following steps:

Step S01: judging whether the acceleration sensor outputs signal: in this step, judging whether the acceleration sensor outputs the signal, namely judging whether the intelligent terminal is shaken by the user, if so, executing step S02; otherwise, continuing to conduct the judgment of this step. The intelligent terminal can be a smart phone, a tablet PC, or other mobile terminals, etc.

Step S02: assigning 1 to the timer, searching the most premium merchant within the first preset distance range by the remote server and sending the searching results to the intelligent terminal: if the judging result of the step S01 is positive, executing this step; in this step, assigning 1 to the timer, searching the most premium merchant within the first preset distance range by the remote server and sending the searching results to the intelligent terminal, wherein the timer is used for calculating the number of times that the acceleration sensor outputs the signal. According to this embodiment, the first preset distance range is 500 m; certainly, under some circumstances of the embodiment, the first preset distance range can be regulated to other values depending on specific circumstances. After this step, executing step S03.

Step S03: judging whether the acceleration sensor outputs a signal once again: in this step, judging whether the acceleration sensor outputs a signal once again, if so, executing step S04; otherwise, continuing to conduct the judgment of this step.

Step S04: judging whether the number of times that the acceleration sensor outputs the signal is less than or equal to a preset number of times: if the judgment result of the step S03 is positive, executing this step; in this step, judging whether the number of times that the acceleration sensor outputs the signal is less than or equal to a preset number of times; according to the embodiment, the preset number of times is 4; in this step, namely judging whether the number of times that the acceleration sensor outputs the signal is less than or equal to 4, if so, executing step S05; otherwise, returning to step S02. According to the embodiment, when the number of times that the acceleration sensor outputs the signal is more than the preset number of times, updating the number of times that the acceleration sensor outputs the signal as 1 and circulating again, namely returning to the step S02 for next turn of search process. Certainly, under some circumstances of the embodiment, the preset number of times can be correspondingly regulated depending on specific circumstances as well.

Step S05: assigning 1 to the timer, searching the most premium merchant within the N^{th} preset distance range by the remote server and sending the searching results to the intelligent terminal, wherein N is equal to the value of timer; if the judgment result of the step S04 is positive, executing this step; in this step, assigning 1 to the timer, searching the most premium merchant within the N^{th} preset distance range by the remote server and sending the searching results to the intelligent terminal. It is worth mentioning that within the preset time range, the distance range of searching the premium merchant is widened as the user shakes the intelligent terminal once, for example, since the user shakes the intelligent terminal, assigning 1 to the timer, and screening a premium merchant from the search result within the first preset distance which is 500 m away from the user; as the user shakes the intelligent terminal again, assigning 2 to the timer, and screening a premium merchant from the search result within the second preset distance which is 1000 m away from the user; as the user shakes the intelligent terminal one more time, assigning 3 to the timer, and screening a premium merchant from the search result within the third preset distance which is 3000 m away from the user; since the user continues to shake the intelligent terminal, assigning 4 to the timer, and screening a premium merchant from the search result within the fourth preset distance which is 5000 m away from the user. The invention provides a search experiencing for somatosensory interaction with the user; the intelligent terminal can receive somatosensory request of the user by interpreting the acceleration sensor and the gravity inductance gauge, so as to conduct deeper search operation; so that the user can feel two kinds of experiencing from both vision and sense; the somatosensory interaction is enhanced and the user experiencing is improved.

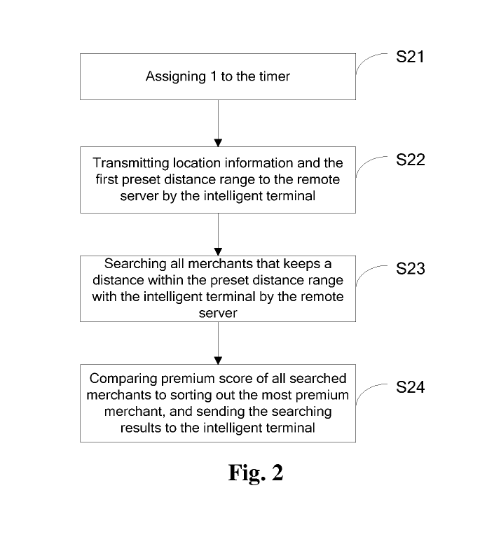

For this embodiment, the step S02 can be further refined, and the flow chart after refining is shown as FIG. 2. In FIG. 2, the step S02 further comprises the following steps:

Step S21: assigning 1 to the timer: in this step, setting the value of the timer as 1.

Step S22: transmitting the location information and the first preset distance range to the remote server by the intelligent terminal: in this step, the location information and the first preset distance range are transmitted to the remote server via a communication module by the intelligent terminal, namely to transmit current location information of the user and the distance range to be searched to the remote server.

Step S23: searching all merchants that keep a distance within the preset distance range with the intelligent terminal by the remote server; in this step, the remote server searches all merchants that keep a distance within the preset distance range with the intelligent terminal, namely the remote server searches all merchants that the linear distance with the intelligent terminal is less than or equal to the first preset distance range.

Step S24: comparing all of the searched merchants to obtain the most premium merchant by the score, and sending the searching results to the intelligent terminal; in this step, the premium score of all searched merchants is compared, the merchant having the highest premium score is sorted out as the most premium merchant, the information of the most premium merchant is sent and displayed on the intelligent terminal, thus realizing search of the most premium merchant within the preset distance range.

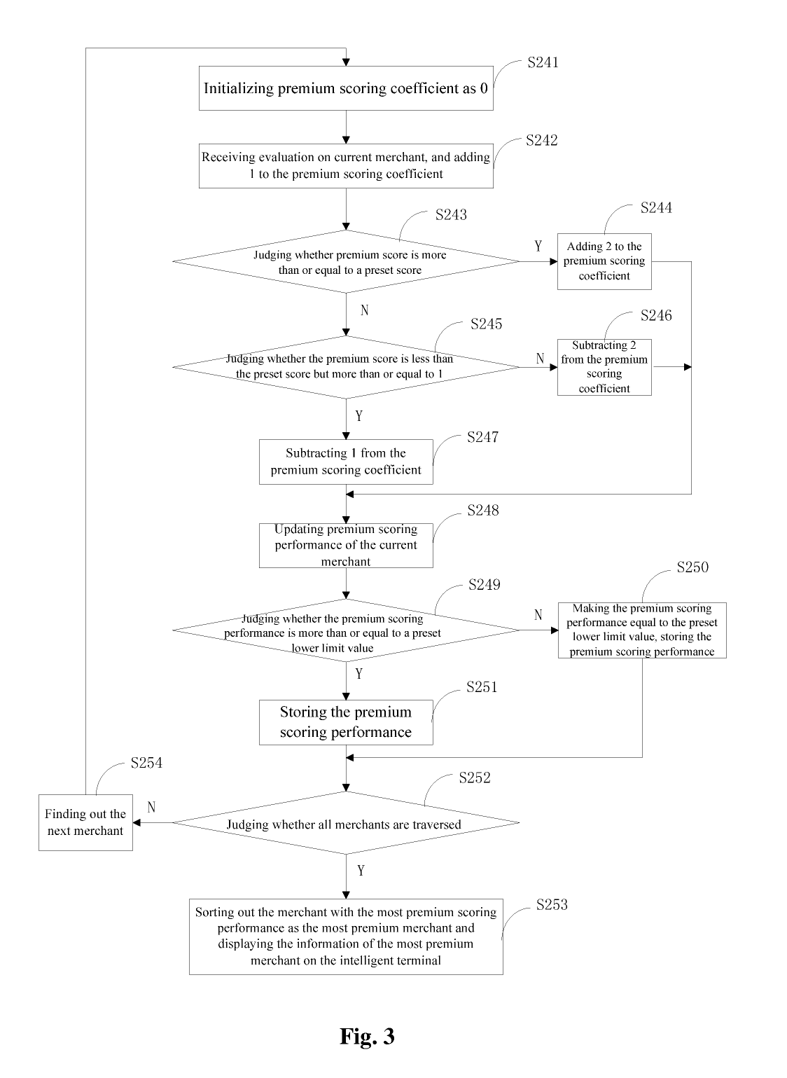

For this embodiment, the step S24 can be further refined, and the flow chart after refining is shown as FIG. 3. In FIG. 3, the step S24 further comprises the following steps:

Step S241: initializing the premium scoring coefficient as 0: in this step: the premium scoring coefficient is initialized as 0 by the control module.

Step S242: receiving evaluation on the current merchant, and adding 1 to the premium scoring coefficient: in this step, the control module receives the evaluation on current merchant, and add 1 to the premium scoring coefficient.

Step S243: judging whether the premium score is more than or equal to a preset score: in this step, judging whether the premium score is more than or equal to a preset score; according to the embodiment, the preset score is 3, which is to judge whether the premium score is more than or equal to 3, if so, executing step S244, otherwise executing step S245. Certainly, under some circumstances of the embodiment, the preset score can be correspondingly regulated depending on specific circumstances as well.

Step S244: adding 2 to the premium scoring coefficient: if the judgment result of the step S243 is positive, executing this step. In this step, the premium scoring coefficient is added with 2. After this step, executing step S248.

Step S245: judging whether the premium score is less than the preset score but more than or equal to 1: if the judgment result of the step S243 is negative, executing this step. In this step, it judges whether the premium score is less than the preset score but more than or equal to 1, namely to judge whether the premium score is less than 3 but more than or equal to 1, if so, executing step S247, otherwise, executing step S246.

Step S246: subtracting 2 from the premium scoring coefficient: if the judgment result of the step S245 is negative, executing the step. In this step, 2 is subtracted from the premium scoring coefficient. After this step, executing step S248.

Step S247: subtracting 1 from the premium scoring coefficient: if the judgment result of the step S245 is positive, executing the step. In this step, 1 is subtracted from the premium scoring coefficient. After this step, executing step S248.

Step S248: updating premium scoring performance of the current merchant: in this step, it updates the premium scoring performance of the current merchant.

Step S249: judging whether the premium scoring performance is more than or equal to a preset lower limit value: in this step, it judges whether the premium scoring performance is more than or equal to a preset lower limit value; according to the embodiment, the lower limit value is −50, which is to judge whether the premium scoring performance is more than or equal to −50; if the judgment result is positive, executing step S251; otherwise, executing step S250.

Step S250: making the premium scoring performance equal to the preset lower limit value and storing the premium scoring performance: if the judgment result of the step S249 is negative, executing the step. In this step, it makes the premium scoring performance equal to the preset lower limit value and stores the premium scoring performance. After this step, executing step S252.

Step S251: storing the premium scoring performance: if the judgment result of the step S249 is positive, executing the step. In this step, it stores the premium scoring performance. After this step, executing step S252.

Step S252: judging whether all merchants are traversed: in this step, it judges whether all merchants are traversed; if the judgment result is positive, executing step S253, otherwise, executing step S254.

Step S253: sorting out the merchant with the most premium scoring performance as the most premium merchant and displaying the information of the most premium merchant on the intelligent terminal: if the judgment result of the step S252 is positive, executing the step. In this step, it finds out the merchant with the highest premium scoring performance as the most premium merchant and displays the information of the most premium merchant on the intelligent terminal.

Step S254: finding out the next merchant: if the judgment result of the step S252 is negative, executing the step. In this step, it finds out the next merchant and returns to step S241. It is worth mentioning that in step S04, when the remote server searches a premium merchant within the N^{th} preset distance range and returns to the intelligent terminal, the search step is implemented in accordance with the specific process of the step S24, namely in accordance with process from step S241 to step S254.

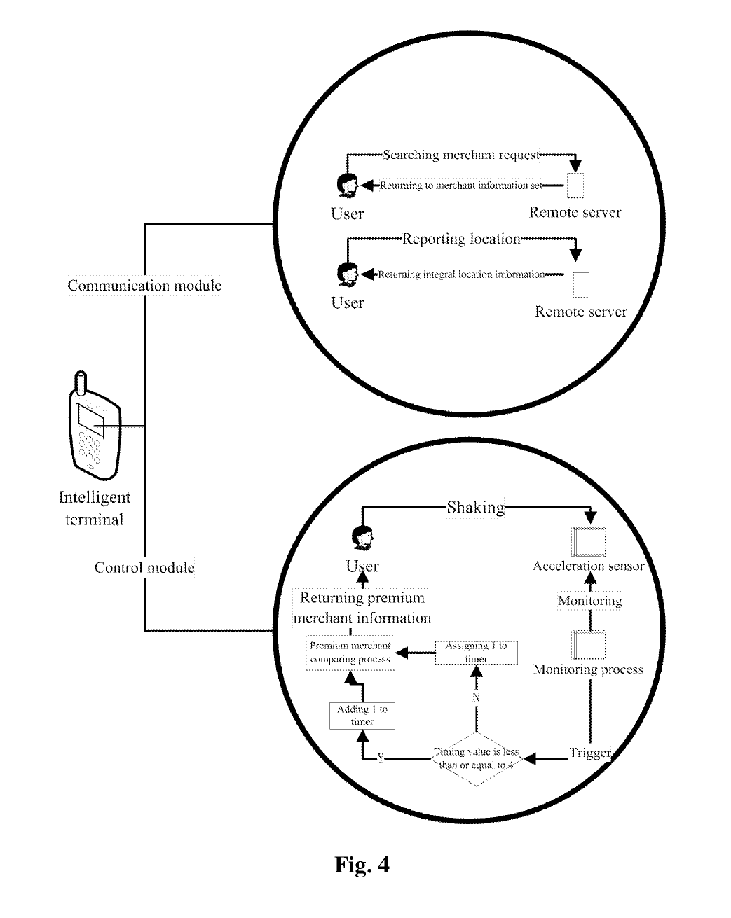

FIG. 4 is a schematic diagram of the interacting process between the intelligent terminal and the remote server according to the embodiment.

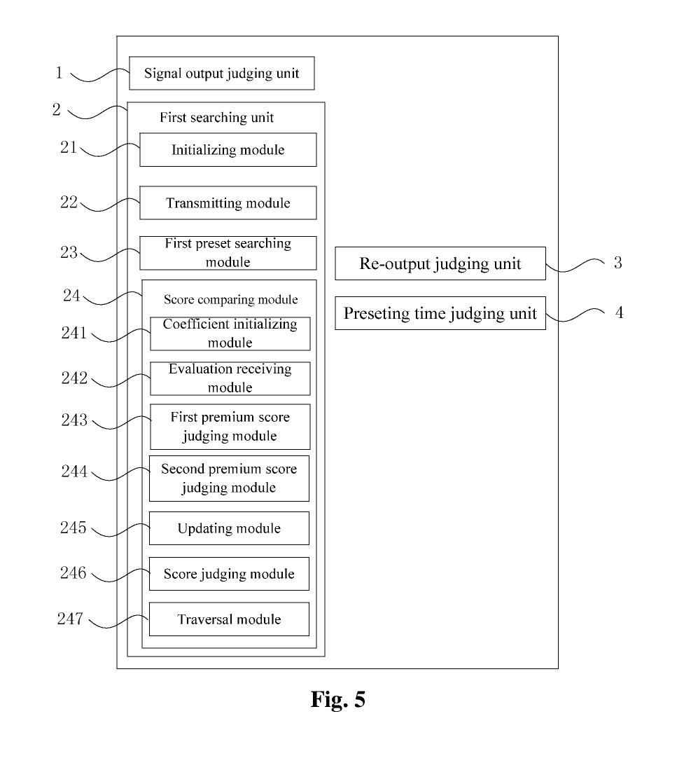

The embodiment further relates to a device for implementing the method for searching the premium merchant based on the intelligent terminal, and the structural schematic diagram is shown in FIG. 5. According to the embodiment, the intelligent terminal is provided with an acceleration sensor and a control module; the acceleration sensor is connected to the control module; the control module is provided with a timer; as shown in FIG. 5, the device comprises a signal output judging unit 1, a first searching unit 2, a re-output judging unit 3 and a preset number of times judging unit 4, wherein, the signal output judging unit 1 is used for judging whether the acceleration sensor outputs the signal; the first searching unit 2 is used for assigning 1 to the timer; the remote server searches the most premium merchant within the first preset distance range and sends the searching results to the intelligent terminal; according to the embodiment, the first preset distance range is 500 m; certainly, under some circumstances, the first preset distance range can be correspondingly regulated depending on specific circumstances; the timer is used for calculating the number of times that the acceleration sensor outputs the signal; the output re-judging unit 3 is used for judging whether the acceleration sensor outputs the signal again; the preset number of times judging unit 4 is used for judging whether the number of times that the acceleration sensor outputs the signal is less than or equal to a preset number of times, if so, adding 1 to the timer; the remote server is used for searching the most premium merchant within the N^{th} preset distance range and sending the searching results to the intelligent terminal, wherein N is equal to the value of the timer, otherwise, returning. It is worth mentioning that, the preset number of times is 4; certainly, under some circumstances, the preset number of times can be correspondingly regulated depending on specific circumstances. The invention provides a search experiencing for somatosensory interaction with the user; the intelligent terminal receives somatosensory request of the user by interpreting the acceleration sensor and the gravity inductance gauge, so as to conduct further search operation; so that the user can feel two kinds of experiencing from both vision and sense; the somatosensory interaction is enhanced and the user experiencing is improved.

According to the embodiment, the first searching unit 2 further comprises an initializing module 21, a transmitting module 22, a first preset searching module 23 and a score comparing module 24, wherein, the initializing module 21 is used for assigning 1 to the timer; the transmitting module 22 is used for transmitting location information and the first preset distance range to the remote server by the intelligent terminal; the first preset searching module 23 is used for searching all merchants of the distance with the intelligent terminal within the preset distance rang by the remote server; the score comparing module 24 is used for comparing premium score of all of the searched merchants to sort out the most premium merchant, and sending the searching results to the intelligent terminal.

According to the embodiment, the score comparing module 24 further comprises a coefficient initializing module 241, an evaluation receiving module 242, a first premium score judging module 243, a second premium score judging module 244, an updating module 245, a score judging module 246 and a traversal unit 247, wherein, the coefficient initializing module 241 is used for initializing the premium scoring coefficient as 0; the evaluation receiving module 242 is used for receiving evaluation on the current merchant, and adding 1 to the premium scoring coefficient; the first premium score judging module 243 is used for judging whether the premium score is more than or equal to a preset score, if so, adding 2 to the premium scoring coefficient; otherwise, continuing to judge the premium score; according to the embodiment, the preset score is 3, under some circumstances, the preset score can be regulated accordingly depending on specific circumstances. the second premium score judging module 244 is used for judging whether the premium score is less than the preset score but more than or equal to 1, if so, subtracting 1 from the premium scoring coefficient; otherwise, subtracting 2 from the premium scoring coefficient; the updating module 245 is used for updating the premium scoring performance of the current merchant; the score judging module 246 is used for judging whether the premium scoring performance is more than or equal to a preset lower limit value, if so, storing the premium scoring performance; otherwise, making the premium scoring performance equal to the preset lower limit value, and storing the premium scoring performance; the traversal unit 247 is used for judging whether all merchants are traversed, if so, sorting out the merchant with the most premium scoring performance as the most premium merchant and displaying the information of the most premium merchant on the intelligent terminal; otherwise, finding out the next merchant and returning. According to the embodiment, the preset lower limit value is −50; certainly, under some circumstances, the preset lower limit value can be correspondingly regulated depending on specific circumstances.

It is worth mentioning that, according to the embodiment, the preset number of times judging unit 4 carries out searching a premium merchant within the N^{th} preset distance range by the remote server and sending the searching results to the intelligent terminal in accordance with process implemented by the score comparing module 24.

In conclusion, according to the embodiment, the remote server, after receiving the location information of the user and the value in the specific distance range, will screen the searching results of merchants and calculate the linear distance from the user to the merchants, access again to a distance range screening process after obtaining the distance values from all merchants to the user, eliminate the merchant information out of the specific range, compare the premium score values of the merchants obtained from secondary screening to obtain the information of the most premium merchant within the distance range, and then display the result on the user interface of the intelligent terminal; therefore, a search experiencing for somatosensory interaction with the user is provided, so as to guarantee two experiencing effects to the user from both vision and sense.

The foregoing embodiments are merely exemplary embodiments of the invention, and not intended to define the scope of the invention, and any modification, equivalent replacement, improvement and the like within the spirits and the principles of the invention shall be included within the protection scope of the invention.

What is claimed is:

1. A method for searching the premium merchant based on an intelligent terminal, wherein: the intelligent terminal is provided with an acceleration sensor and a control module connected to the acceleration sensor; the control module is provided with a timer; the method comprises:
A) Judging whether the acceleration sensor outputs a signal, if so, executing step B); otherwise, continuing to conduct the judgment of this step;
B) Assigning 1 to the timer, searching the most premium merchant within a first preset distance range by a remote server and sending the searching results to the intelligent terminal, and executing step C), wherein the timer is used for calculating the number of times that the acceleration sensor outputs the signal;
C) Judging whether the acceleration sensor outputs a signal once again, if so, executing step D); otherwise, continuing to conduct the judgment of this step;
D) Judging whether the number of times that the acceleration sensor outputs the signal is less than or equal to a preset number of times, if so, adding 1 to the timer, searching the most premium merchant within the N^{th} preset distance range by the remote server and sending the searching results to the intelligent terminal, wherein N is equal to the numerical value of the timer; otherwise, returning to step B).

2. The method for searching the premium merchant based on the intelligent terminal according to claim 1, wherein, the step B) further comprises:
B1) Assigning 1 to the timer;
B2) Transmitting the location information and the first preset distance range to the remote server by the intelligent terminal;
B3) Searching all merchants that keeps a distance within the first preset distance range with the intelligent terminal by the remote server;
B4) Comparing all of the searched merchants to obtain the most premium merchant by the score, and sending the searching results to the intelligent terminal.

3. The method for searching the premium merchant based on the intelligent terminal according to claim 2, wherein, the step B4) further comprises:
B41) Initializing premium scoring coefficient as 0;
B42) Receiving evaluation on the current merchant, and adding 1 to the premium scoring coefficient;
B43) Judging whether the premium score is more than or equal to the preset score, if so, adding 2 to the premium scoring coefficient and executing step B45); otherwise, executing step B44);
B44) Judging whether the premium score is less than the preset score but more than or equal to 1, if so, subtracting 1 from the premium scoring coefficient and executing step B45); otherwise, subtracting 2 from the premium scoring coefficient and executing step B45);
B45) Updating premium scoring performance of the current merchant;
B46) Judging whether the premium scoring performance is more than or equal to a preset lower limit value, if so, storing the premium scoring performance and executing step B47); otherwise, making the premium scoring performance equal to the preset lower limit value, storing the premium scoring performance and executing step B47);
B47) Judging whether all merchants are traversed, if so, sorting out the merchant with the most premium scoring performance as the most premium merchant and displaying the information of the most premium merchant on the intelligent terminal; otherwise, finding out the next merchant and returning to step B41).

4. The method for searching the premium merchant based on the intelligent terminal according to claim 3, wherein, the step D) of searching a premium merchant within the N^{th} preset distance range by the remote server and sending the searching results to the intelligent terminal is carried out in accordance with process of the step B4).

5. The method for searching the premium merchant based on the intelligent terminal according to claim 4, wherein, the first preset distance range is 500 m, the preset number of times is 4, the preset score is 3 and the preset lower limit value is −50.

6. A device for implementing the method for searching the premium merchant based on the intelligent terminal according to claim 1, wherein: the intelligent terminal is provided with an acceleration sensor and a control module connected to the acceleration sensor; the control module is provided with a timer; the device comprises:
A signal output judging unit: for judging whether the acceleration sensor outputs a signal;
A first searching unit: for assigning 1 to the timer, searching the most premium merchant within a first preset distance range by a remote server and sending the searching results to the intelligent terminal, wherein the timer is used for calculating the number of times that the acceleration sensor outputs the signal;
A re-output judging unit: for judging whether the acceleration sensor outputs a signal once again;
A preset number of times judging unit: for judging whether the number of times that the acceleration sensor outputs the signal is less than or equal to a preset number of times, if so, adding 1 to the timer, searching the most premium merchant within the N^{th} preset distance range by the remote server and sending the searching results to the intelligent terminal, wherein N is equal to the value of the timer; otherwise, returning.

7. The device for implementing the method for searching the premium merchant based on the intelligent terminal according to claim 6, wherein, the first searching unit further comprises:
An initializing module: for assigning 1 to the timer;
A transmitting module: for transmitting location information and the first preset distance range to the remote server by the intelligent terminal;
A first preset searching module: for searching all merchants of the distance with the intelligent terminal within the first preset distance range by the remote server;
A score comparing module: for comparing all of the searched merchants to obtain the most premium merchant by the score, and sending the searching results to the intelligent terminal.

8. The device for implementing the method for searching the premium merchant based on the intelligent terminal according to claim 7, wherein, the score comparing module further comprises:
A coefficient initializing module: for initializing premium scoring coefficient as 0;
An evaluation receiving module: for receiving evaluation on the current merchant, and adding 1 to the premium scoring coefficient;
A first premium score judging module: for judging whether the premium score is more than or equal to a preset score, if so, adding 2 to the premium scoring coefficient; otherwise, continuing to judge the premium score;
A second premium score judging module: for judging whether the premium score is less than the preset score but more than or equal to 1, if so, subtracting 1 from the premium scoring coefficient; otherwise, subtracting 2 from the premium scoring coefficient;
An updating module: for updating the premium scoring performance of the current merchant;
A score judging module: for judging whether the premium scoring performance is more than or equal to a preset lower limit value, if so, storing the premium scoring performance; otherwise, making the premium scoring performance equal to the preset lower limit value, storing the premium scoring performance;
A traversal unit: for judging whether all merchants are traversed, if so, sorting out the merchant with the most premium scoring performance as the most premium merchant and displaying the information of the most premium merchant on the intelligent terminal; otherwise, finding out the next merchant and returning.

9. The device for implementing the method for searching the premium merchant based on the intelligent terminal according to claim 8, wherein, the preset number of times judging unit carries out searching a premium merchant within the N^{th} preset distance range by the remote server and sending the searching results to the intelligent terminal in accordance with process implemented by the score comparing module.

10. The device for implementing the method for searching the premium merchant based on the intelligent terminal according to claim 9, wherein, the first preset distance range is 500 m, the preset number of times is 4, the preset score is 3 and the preset lower limit value is −50.
